(19) United States
(12) Patent Application Publication
(10) Pub. No.: US 2017/0216133 A1
(43) Pub. Date: Aug. 3, 2017

(54) Massage Roller

(71) Applicant: Chinchin Yih, New Taipei City (TW)

(72) Inventor: Chinchin Yih, New Taipei City (TW)

(21) Appl. No.: 15/422,265

(22) Filed: Feb. 1, 2017

Related U.S. Application Data
(60) Provisional application No. 62/289,952, filed on Feb. 2, 2016.

(51) Int. Cl. A61H 15/00; A61H 1/00

(52) U.S. Cl. CPC A61H 15/0092; A61H 1/008

(57) ABSTRACT

A massage roller includes a cylindrical tube body having an inner surface; a supporting core attached on the inner surface of the cylindrical tube body to form a cylindrical cavity; and a filing unit disposed inside the cylindrical cavity to improve the strength of the massage roller.

### CROSS REFERENCE OF RELATED APPLICATION

This is a non-provisional application that claims priority to U.S. provisional application, application Ser. No. 62/289,952, filed Feb. 2, 2016, the entire contents of each of which are expressly incorporated herein by reference.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

Field of Invention

The present invention relates to a massage device, and more particularly to a massage roller which has cheaper in cost and lighter in weight than the conventional massage rollers.

Description of Related Arts

A conventional massage roller comprises a roller body, a cylindrical supporting core deposited inside the tube body, a core interior extended through the cylindrical supporting core, and a plurality of protruding pieces with substantially similar shapes formed at an outer surface of the tube body, wherein the cylindrical supporting core is generally made of a hard and heavy material, such as PVC and PPE, so the massage roller is easily to be broken and damaged by bearing external forces and impacts.

The conventional massage roller has several drawbacks. First, PVC and PPE are not eco-friendly materials, so it may cause more and more pollutants for our environment during recovering of the conventional massage roller. In common treatment for PVC and PPE, the PVC and PPE waste are buried into landfills, but the space for burying the PVE and PPE waste is limited. Secondly, if the manufacturers try to use the eco-family PVC and PPE materials, the cost and weight of the massage roller is naturally increased. Therefore, cheaper materials for the cylindrical supporting core or an improved structure are highly desired to decrease the manufacture cost of the massage roller.

### SUMMARY OF THE PRESENT INVENTION

The invention is advantageous in that it provides a massage roller which comprises a supporting core deposed inside the tube body to improve the strength of the massage roller.

Another advantage of the invention is to provide a massage roller, wherein the supporting core is light in weight and economic in cost, so as to greatly decrease the manufacturing cost of the massage roller.

Another advantage of the invention is to provide a massage roller, wherein the supporting core is made of eco-friendly material, so not only the process of the recovering treatment of the massage roller is simple, but also the recovering cost thereof is naturally decreased.

Another advantage of the invention is to provide a massage roller, wherein no expansive and complicated structure is required to be employed in the present invention in order to achieve the above mentioned objects. Therefore, the present invention successfully provides an economic and efficient solution to greatly decrease the manufacturing cost of the massage roller.

Additional advantages and features of the invention will become apparent from the description which follows, and may be realized by means of the instrumentalities and combinations particular point out in the appended claims.

According to the present invention, the foregoing and other objects and advantages are attained by a massage roller, comprising:
a cylindrical tube body having an inner surface;
a supporting core attached on an inner surface of the cylindrical tube body to form a cylindrical cavity; and
a filing unit disposed inside the cylindrical cavity to improve the strength of the massage roller.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a massage roller according to a preferred embodiment of the present invention.

FIG. 2 is a side view of a massage roller according to the above preferred embodiment of the present invention.

FIG. 3 is a side view of an alternative mode of a supporting core according to the above preferred embodiment of the present invention.

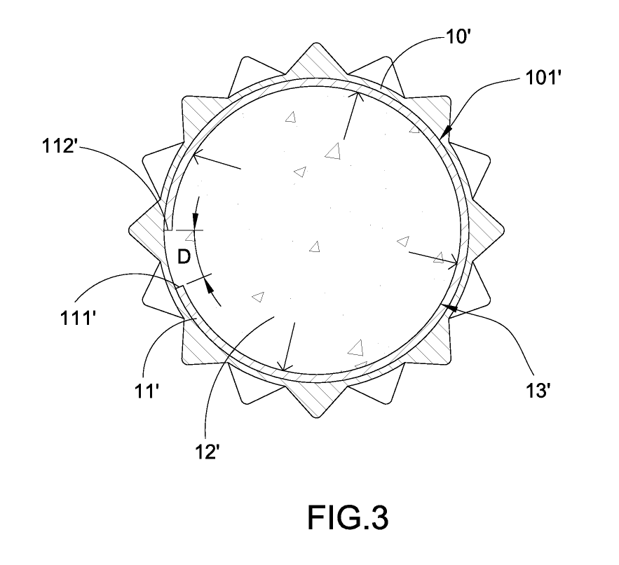

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

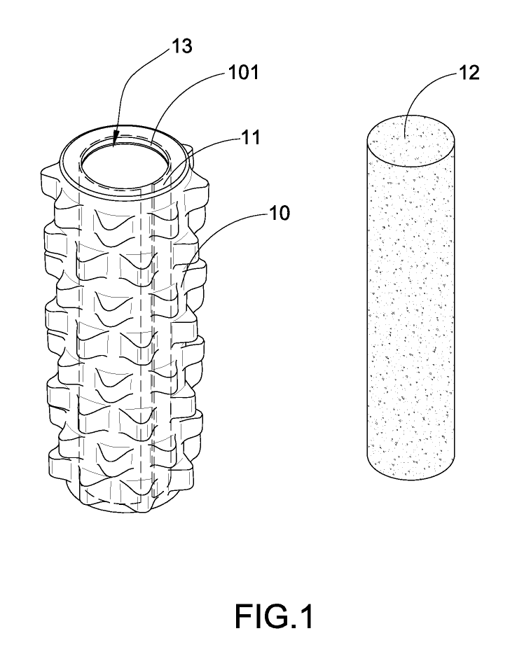

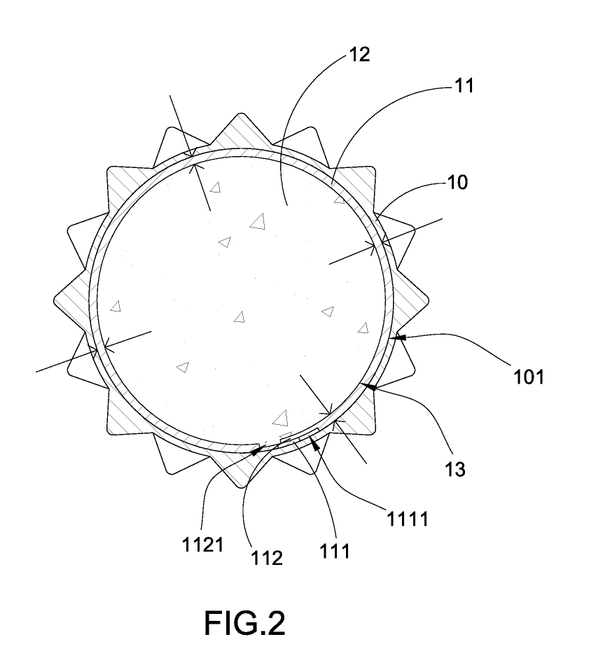

Referring to FIG. 1 to FIG. 2 of the drawings, a massage roller according to a preferred embodiment of the present invention is illustrated, wherein the massage roller comprises a cylindrical tube body 10 having an inner surface 101, a supporting core 11 deposed inside the cylindrical tube body 10 to from a receiving cavity 13, and a filing unit 12 deposited inside the cylindrical cavity 13 to improve the strength of the massage roller.

As shown in FIG. 2, the supporting core 11 is overlapped on an inner surface of the cylindrical tube body 10 to increase the strength and flexible of the massage roller, wherein the supporting core 11 is preferably made of light in weight, economic in cost materials, and strong flexibility materials, such as hardboard. Therefore, not only the manufacturing cost thereof, but also the strength of the structure of the massage roller is increased.

Accordingly, the supporting core 11 comprises a first portion 111 and a second portion 112 selectively connected with the first portion 111 while the supporting core 11 is attached on the inner surface 101 of the cylindrical tube body 10. The first portion 111 comprises a first sliding slot 1111 for receiving the second portion 112, and the second portion 112 comprises a second sliding slot 1121 for receiving the first portion, wherein the first portion 111 is slidably moving along the second sliding slot 1121, and the second portion 112 is slidably moving along the first sliding slot 1111. It is worth mentioning that the first portion 111 is moved along the second sliding slot 1121 at a direction as well as the second portion 112 is moving along the first sliding slot 1111 at an opposite direction while an external force is applied on the tube body 10. The first portion 111 and the second portion 112 are inwardly moved in opposite direction while the external force is applied on the tube body 10. On the other hand, the first portion 111 and the second portion 112 are outwardly moved in opposite direction while the external force is released from the tube body.

Accordingly, the first sliding slot 1111 and the second sliding slot 1112 provide bouncing spaces for the first portion 111 and the second portion 112. While the external force is applied on the tube body 10, the structure of the supporting core will not be broken due to the compression of the tube body 10. In other words, the structure of the supporting core has more flexibility to endure much larger amount of external force.

The filing unit 12 is made of foam-like material. Since the filing unit 12 is deposited inside the cylindrical cavity 13, the supporting core 11 is sandwiched between the cylindrical tube body 10 and the filing unit 12. The supporting core 11 is adapted to provide inwardly compressing forces to the filing unit 12 to make the deformation of the filing unit 12 while the external forces and impacts are exerted on the cylindrical tube body 10, and outwardly resistance forces are generated from the filing unit 12 to overcome the inwardly compressing forces to make the filing unit 12 and the supporting core 11 reinstate to their original shapes while the external forces and impacts are released from the cylindrical tube body 10. Therefore, overall flexibility of the cylindrical tube body 10 is increased by the structure and materials of the supporting core 10.

Accordingly, the cylindrical tube body 10 further comprises a plurality of protruding pieces 101 with substantially similar shapes formed at an outer surface of the tube body 10 configured to provide a massage effect.

Referring to FIG. 4, an alternative mode of the supporting core 11′ of the cylindrical tube body 10′ of the massage roller according to the above preferred embodiment of the present invention is illustrated, wherein the supporting core 11′ is a C-shaped configuration.

Accordingly, the C-shaped supporting core 11′ is slidably attached on an inner surface 101′ of the cylindrical tube body 10′ having a first portion 111′ and a second portion 112′, wherein a clearance “D” is defined between the first portion 111′ and the second portion 112′. A length of the clearance D can be changed by the external forces and impacts applied on the tube body 10′. The first portion 111′ and the second portion 112′ are synchronically moved towards each other while the external forces and impacts are exerted on the cylindrical tube body 10′ as well as that the length of the clearance D is decreased, and at the same time, the inwardly compressing forces are generated from the supporting core 11′ towards the filing unit 12′ to case the deformation of the filing unit 12′. After the external forces and impacts are released from the cylindrical tube body 10′, outwardly resistance forces are generated from the filing unit 12′ to make the filing unit 12′ being reinstated to its original shapes, and at the same time, the first portion 111′ and the second portion 112′ are synchronically moved away from each other as well as the length of the clearance D is reinstated to its original length.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A massage roller, comprising:
a cylindrical tube body having an inner surface;
a supporting core slidably attached on an inner surface of said cylindrical tube body to form a cylindrical cavity; and
a filing unit disposed inside said cylindrical cavity to improve the strength of the massage roller.

2. The massage roller, as recited in claim 1, wherein said supporting core comprises a first portion and a second portion slidably moving along a second sliding slot of said second portion and a first sliding slot of said first portion respectively.

3. The massage roller, as recited in claim 2, wherein said first portion and said second portion are synchronically moved along said second and first sliding slots respectively while an external force is applied or released from said tube body.

4. The massage roller, as recited in claim 1, wherein said supporting core has a C-shaped configuration.

5. The massage roller, as recited in claim 2, wherein said supporting core is made of light in weight and flexibility materials

6. The massage roller, as recited in claim 2, wherein said supporting core is made of hardboard.

7. The massage roller, as recited in claim 4, wherein said supporting core is made of light in weight and flexibility materials

8. The massage roller, as recited in claim 4, wherein said supporting core is made of hardboard.

9. The massage roller, as recited in claim 4, wherein said supporting core comprises a first portion and a second portion spacedly arranged with said first portion to define a clearance.

10. The massage roller, as recited in claim 9, wherein said first portion are moved towards a direction as well as that said second portion are moved towards an opposite direction to selectively decrease a length of said contacting distance.

11. The massage roller, as recited in claim 9, wherein said first portion are moved towards a direction as well as that said second portion are moved towards an opposite direction to selectively increase a length of said contacting distance.

12. The massage roller, as recited in claim 10, wherein inwardly compressing forces are generated from said supporting core towards said filing unit to deform said filing unit as well as the length of said contacting surface is increased.

13. The massage roller, as recited in claim 11, wherein outwardly resistance forces are generated from said filing unit towards said supporting core to reinstate said filing unit and said supporting core to their original shapes as well as the length of said contacting surface is decreased.

14. The massage roller, as recited in claim 9, wherein said first and second portion are synchronically moved in opposite direction along said inner surface of said tube body.
